(19) United States
(12) Patent Application Publication
(10) Pub. No.: US 2014/0161014 A1
(43) Pub. Date: Jun. 12, 2014

(54) MOBILE COMMUNICATION SYSTEM, RADIO BASE STATION, MOBILE STATION, DATA TRANSMISSION METHOD, DATA RECEPTION METHOD, AND COMPUTER READABLE MEDIUM

(71) Applicant: Takahiro Sasaki, Tokyo (JP)

(72) Inventor: Takahiro Sasaki, Tokyo (JP)

(73) Assignee: NEC Corporation, Tokyo (JP)

(21) Appl. No.: 14/232,588

(22) PCT Filed: Jun. 25, 2012
(86) PCT No.: PCT/JP2012/004106

§ 371 Date: Jan. 13, 2014

(30) Foreign Application Priority Data
Jul. 25, 2011 (JP) 2011-162332

(51) Int. Cl. H04W 52/02; H04W 72/00

(52) U.S. Cl. CPC H04W 52/0212; H04W 72/005
USPC 370/311

(57) ABSTRACT

The aim of the present invention is to provide a mobile communication system that can reduce power consumption in transmitting unicast information using subframes assigned for transmission of multicast information. The mobile communication system of the present invention comprises a radio base station configured so as to notify a mobile station of first information on whether to transmit unicast information using a first radio resource group, when it is specified that the first radio resource group can be utilized for transmission of multicast information and the unicast information and includes a plurality of radio resources, and that a second radio resource group is different from the first radio resource group; and the mobile station configured so as to control reception operation of the first radio resource group based on the first information received from the radio base station.

### TECHNICAL FIELD

The present invention relates to a mobile communication system that transmits multicast information and unicast information and, in particular, to a technology to notify a mobile station of a radio resource used for transmitting the unicast information.

### BACKGROUND ART

Methods for data transmission include a method for transmitting unicast information to a communication terminal and a method for transmitting multicast/broadcast information to communication terminals. Unicast information is information directed to a single communication terminal, and multicast/broadcast information is information simultaneously reported or broadcast to a plurality of terminals. In a communication system that provides data communication to communication terminals, various technologies have been devised in order to mix the method for transmitting unicast information to the communication terminal with the method for transmitting multicast/broadcast information to the communication terminals.

A configuration of a wireless LAN system is disclosed as a communication system in Patent Literature 1. The wireless LAN system includes an AP (access point) and a plurality of radio stations. The radio station operates in a state where it is set in a continuous active mode or a power-saving mode. The radio station set in the power-saving mode is powered up in synchronization with a period in which a beacon frame is transmitted from the AP, and receives the beacon frame. The radio station can recognize whether or not data for the radio station itself is buffered in the AP by analyzing bit map information in a TIM (traffic information map) element included in the beacon frame. Furthermore, the radio station can identify whether data addressed to the radio station itself is unicast information or multicast/broadcast information by using the bit map information.

In the manner described above, the radio station can receive the unicast information or the multicast/broadcast information. In addition, the radio station can achieve power saving by transitioning to a sleep state when there is no data addressed thereto.

Furthermore, also in LTE (Long Term Evolution) of 3GPP (3rd Generation Partnership Project), the following method is used in order to mix the method for transmitting unicast information to a communication terminal with the method for transmitting multicast/broadcast information to communication terminals.

Two types of subframes are used in LTE of 3GPP. The two types of subframes are a normal subframe in which unicast information (a PDSCH) is transmitted, and an MBSFN subframe in which multicast information (a PMCH) (broadcast information is included) is transmitted. These two types of subframes differ in the specifications of a physical layer, such as arrangement of a reference signal (Non Patent Literature 1). The subframe includes a plurality of time slots. These two types of subframes are arranged in a network by a network operator, and a base station apparatus reports this arrangement to all terminal apparatuses (Non Patent Literature 2).

With reference to FIG. 19, a method for utilizing a subframe in 3GPP Release 8/9 and Release 10 will be explained. In LTE (3GPP Release 8/9), in the MBSFN subframe, the multicast information (PMCH) can be transmitted, while the unicast information (PDSCH) cannot be transmitted. Furthermore, in LTE (3GPP Release 9), in the MBSFN subframe, in addition to the multicast information, a Positioning Reference Signal can be transmitted. The Positioning Reference Signal is the signal used for positional measurement.

In contrast with the above, in a TM 9 (transmission mode 9) employed in LTE-Advanced (3GPP Release 10) which LTE has been evolved into, the specifications have been expanded so that unicast information can be transmitted using a subframe that is not used for transmission of multicast information among the MBSFN subframes (Non Patent Literature 3).

### CITATION LIST

### Patent Literature

[Patent Literature 1]
Published Japanese Translation of PCT International Publication for Patent Application, No. 2011-501488

### Non Patent Literature

[Non Patent Literature 1]

3GPP TS36.211 v10.2.0 (2011-06), “Evolved Universal Terrestrial Radio Access (E-UTRA); Physical Channels and Modulation (Release 10)”
[Non Patent Literature 2]

3GPP TS36.331 v10.2.0 (2011-06), “Evolved Universal Terrestrial Radio Access (E-UTRA); Radio Resource Control (RRC); Protocol specification (Release 10)”
[Non Patent Literature 3]

3GPP TS36.213 v10.2.0 (2011-06), “Evolved Universal Terrestrial Radio Access (E-UTRA); Physical layer procedures (Release 10)”

### SUMMARY OF INVENTION

### Technical Problem

The inventors of the present application have found that there is a problem mentioned below in communication terminals that operate in the TM 9 receiving data in a network environment of the LTE-Advanced. Namely, the communication terminals that receive multicast information among the communication terminals that operate in the TM 9 can recognize MBSFN subframes actually used for transmission of the multicast information among the MBSFN subframes. That is, the communication terminals that receive the multicast information are able to know the MBSFN subframe that can be used for unicast information. Therefore, the communication terminal performs a reception operation for unicast information in the MBSFN subframe that can be used for the unicast information, while it need not perform a reception operation for the unicast information in the MBSFN subframes that are recognized to be useable for the multicast information.

In contrast with the above, the communication terminal that does not receive the multicast information cannot recognize the MBSFN subframe used for transmission of the unicast information among the MBSFN subframes. Therefore, there is a problem that when the MBSFN subframes exist, the communication terminal that does not receive the multicast information needs to perform a reception operation for the unicast information in all the MBSFN subframes regardless of whether or not the MBSFN subframes are actually used for transmission of the unicast information, and thus waste of power consumption cannot be avoided.

In order to solve the above problem, the aim of the present invention is to provide a mobile communication system, a radio base station, a mobile station, a data transmission method, a data reception method, and a program that can reduce power consumption in transmitting unicast information using subframes assigned for transmission of multicast information.

### Solution to Problem

A first exemplary aspect of the present invention is a mobile communication system comprising: a radio base station configured so as to notify a mobile station of first information on whether to transmit unicast information using a first radio resource group, when it is specified that the first radio resource group can be utilized for transmission of multicast information and the unicast information and includes a plurality of radio resources, and that a second radio resource group is different from the first radio resource group; and the mobile station configured so as to control reception operation of the first radio resource group based on the first information received from the radio base station.

A second exemplary aspect of the present invention is a radio base station comprising data transmission means for transmitting first information on whether to transmit unicast information using a first radio resource group when it is specified that the first radio resource group can be utilized for transmission of multicast information and the unicast information and includes a plurality of radio resources, and that a second radio resource group is different from the first radio resource group.

A third exemplary aspect of the present invention is a mobile station comprising reception operation control means for controlling reception operation of a first radio resource group based on first information on whether or not unicast information is transmitted from a radio base station using the first radio resource group, when it is specified that the first radio resource group can be utilized for transmission of multicast information and the unicast information and includes a plurality of radio resources, and that a second radio resource group is different from the first radio resource group.

A fourth exemplary aspect of the present invention is a data transmission method, wherein when it is specified that a first radio resource group can be utilized for transmission of multicast information and unicast information and includes a plurality of radio resources, and that a second radio resource group is different from the first radio resource group, first information on whether to transmit the unicast information is transmitted to a mobile station using the first radio resource group.

A fifth exemplary aspect of the present invention is a data reception method, wherein when it is specified that a first radio resource group can be utilized for transmission of multicast information and unicast information and includes a plurality of radio resources, and that a second radio resource group is different from the first radio resource group, reception operation for the first radio resource group is controlled based on first information on whether or not the unicast information is transmitted from a radio base station using the first radio resource group.

A sixth exemplary aspect of the present invention is a program, wherein a program is stored that makes a computer execute processing that transmits to a mobile station first information on whether to transmit unicast information using a first radio resource group, when it is specified that the first radio resource group can be utilized for transmission of multicast information and the unicast information and includes a plurality of radio resources, and that a second radio resource group is different from the first radio resource group.

### Advantageous Effects of Invention

According to the present invention, a mobile communication system, a radio base station, a mobile station, a data transmission method, a data reception method, and a program that can reduce power consumption in transmitting unicast information using subframes assigned for transmission of multicast information can be provided.

### BRIEF DESCRIPTION OF DRAWINGS

FIG. 1 is a configuration diagram of a mobile communication system pertaining to an embodiment 1.

FIG. 2 is a configuration diagram of a base station pertaining to the embodiment 1.

FIG. 3 is a diagram illustrating radio resources pertaining to the embodiment 1.

FIG. 4 is a diagram illustrating an SIB 13 of LTE-Advanced pertaining to the embodiment 1.

FIG. 5 is a diagram showing a bit map of report information pertaining to the embodiment 1.

FIG. 6 is a flow chart of report information notification processing of the base station pertaining to the embodiment 1.

FIG. 7 is a configuration diagram of a mobile station pertaining to the embodiment 1.

FIG. 8 is a table illustrating a reception operation for MBSFN subframes pertaining to the embodiment 1.

FIG. 9 is a table illustrating a reception operation for the MBSFN subframes pertaining to the embodiment 1.

FIG. 10 is a flow chart of a reception processing of the MBSFN subframes of the mobile station pertaining to the embodiment 1.

FIG. 11 is a flow chart of reception processing of the MBSFN subframes of the mobile station pertaining to the embodiment 1.

FIG. 12 is a configuration diagram of a base station pertaining to an embodiment 2.

FIG. 13 is a diagram illustrating an RRCConnectionSetup message pertaining to the embodiment 2.

FIG. 14 is a configuration diagram of a base station pertaining to an embodiment 3.

FIG. 15 is a diagram showing a bit map of MAC control information pertaining to the embodiment 3.

FIG. 16 is a diagram showing a bit map corresponding to MBSFN subframes pertaining to an embodiment 4.

FIG. 17 is a diagram showing mapping of a period of the MBSFN subframes and a bit map pertaining to the embodiment 4.

FIG. 18 is a diagram showing mapping of a period of the MBSFN subframes and a bit map pertaining to the embodiment 4.

FIG. 19 is a diagram showing a method for utilizing subframes specified in 3GPP.

### DESCRIPTION OF EMBODIMENTS

### Embodiment 1

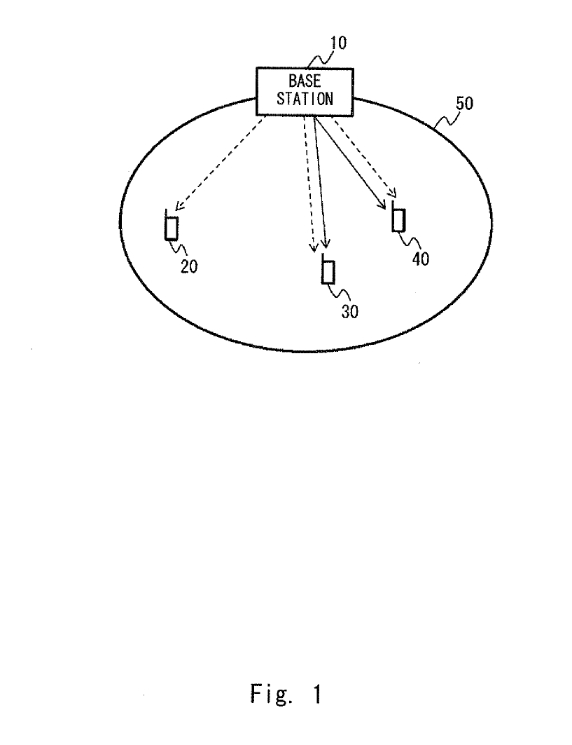

Hereinafter, embodiments of the present invention will be explained with reference to drawings. A configuration example of a mobile communication system pertaining to an embodiment 1 of the present invention will be explained referring to FIG. 1. The mobile communication system is provided with a base station 10 and mobile stations 20, 30, and 40. In addition, the mobile stations 20, 30, and 40 are in a service area of a cell 50 including the base station 10. In FIG. 1, dashed lines from the base station 10 to the mobile stations 20, 30, and 40 indicate transmission of unicast information. In addition, continuous lines from the base station 10 to the mobile stations 30 and 40 indicate transmission of multicast information. The mobile station 20 does not receive the multicast information; it receives only the unicast information. The mobile stations 30 and 40 receive both the multicast information and the unicast information.

The base station 10 is configured so as to notify the mobile stations 20, 30, and 40 of information on whether to transmit unicast information using a radio resource group for multicast among the radio resource group for multicast that can be utilized for transmission of multicast information and the unicast information and includes a plurality of radio resources, and a radio resource group in addition to the radio resource group for multicast.

In addition, the mobile stations 20, 30, and 40 are configured so as to control a reception operation of the radio resource group for multicast based on the information on whether to transmit the unicast information using the radio resource group for multicast, the information having been received from the base station 10.

As explained above, by using the mobile communication system pertaining to FIG. 1, the base station 10 can transmit to the mobile stations 20, 30, and 40 information on whether to transmit the unicast information using the radio resource group for multicast. As a result of this, since the mobile stations 20, 30, and 40 can control the reception operation of the radio resource group for multicast, for example, a power-saving operation can be performed based on the information on whether to transmit the unicast information using the radio resource group for multicast.

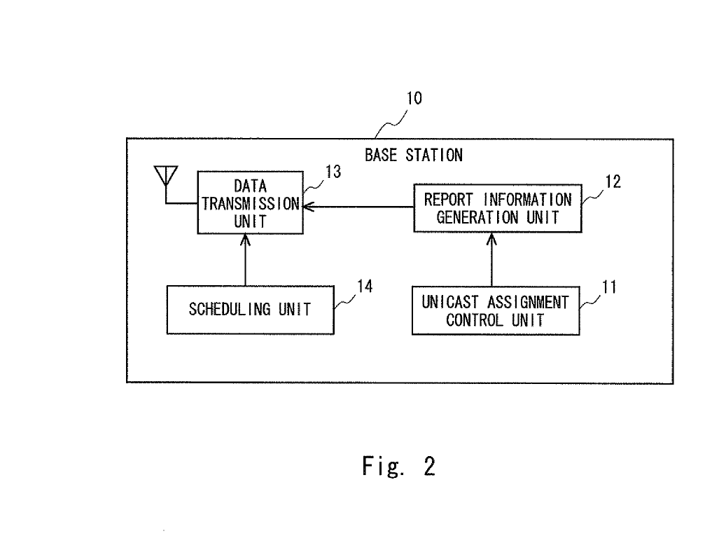

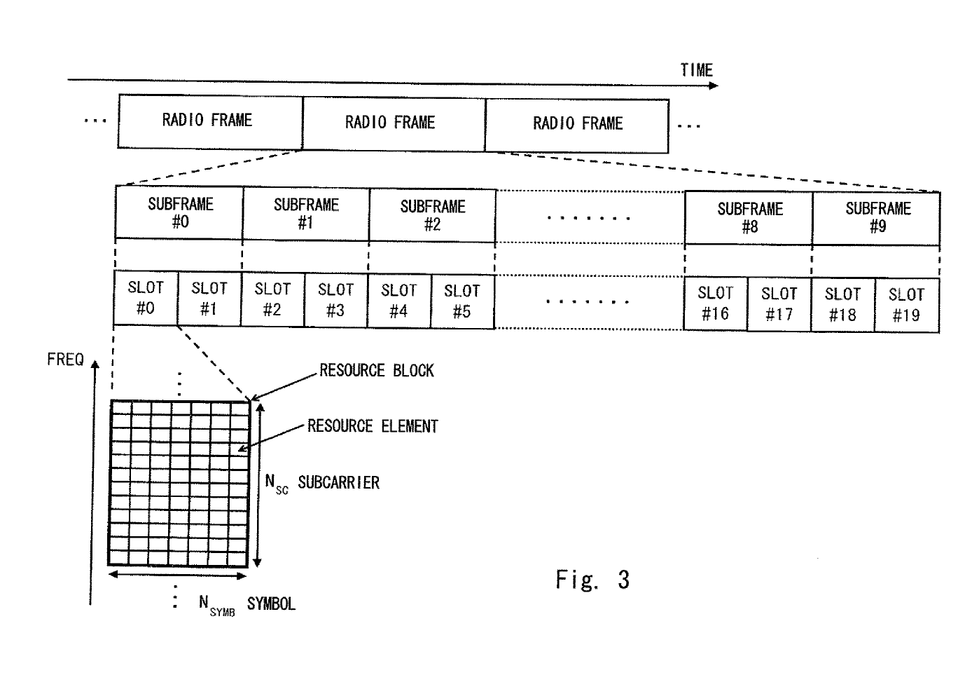

Subsequently, referring to FIG. 2, a configuration example of the base station 10 pertaining to the embodiment 1 of the present invention will be explained. The base station 10 is provided with: a unicast assignment control unit 11; a report information generation unit 12; a data transmission unit 13; and a scheduling unit 14. In addition, referring to FIG. 2, respective components of the base station 10 will be explained mainly using subframes as an example of a radio resource group. Hereinafter, using FIG. 3, a frame configuration used in LTE having compatibility with LTE-Advanced will be explained.

Downlink transmission and uplink transmission between the base station and the respective mobile stations are performed with a radio frame of 10 ms being set as a unit. FIG. 3 is a diagram showing a radio frame composition of FDD (Frequency Division Duplex) of LTE. One radio frame includes ten subframes (#0 to #9). Each subframe includes two slots (or time slots). One slot length is 0.5 ms. Each slot includes a plurality of (N_{SYMB} pieces of) OFDM symbols in a time domain. A radio resource specified by one OFDM symbol in the time domain and one subcarrier in a frequency domain is called a “resource element”. The resource element is a minimum assignment unit of the radio resource in a downlink of LTE/E-UTRAN that employs ODFM (Orthogonal Frequency Division Multiplexing). In addition, a resource unit specified by the N_{SYMB} pieces of contiguous OFDM symbols (for one slot) in the time domain and N_{SC} pieces of contiguous OFDM subcarriers in the frequency domain are called a “resource block”. In a case of a cyclic prefix normally used except in a case of responding to a special multipath environment, a value of N_{SYMB} is 7 and a value of N_{SC} is 12 in the downlink of LTE.

The radio resources are a resource element, a resource block, etc. The radio resource groups are a collection of a plurality of resource blocks, a subframe including a plurality of slots (time slots), etc.

As shown in FIG. 19, unicast information and multicast information are assigned to a subframe unit. A subframe that can be utilized for transmission of the multicast information and the unicast information is set as an MBSFN subframe, and a subframe that can be utilized for transmission of the unicast information is set as a normal subframe. However, the normal subframe is not limited to the subframe that can be utilized for transmission of the unicast information and, for example, it may be a subframe used to transmit information other than the multicast information.

Returning to FIG. 2, the unicast assignment control unit 11 decides whether to assign the unicast information to the MBSFN subframe. The unicast assignment control unit 11 outputs to the report information generation unit 12 information relating to its decision whether to assign the unicast information to the MBSFN subframe.

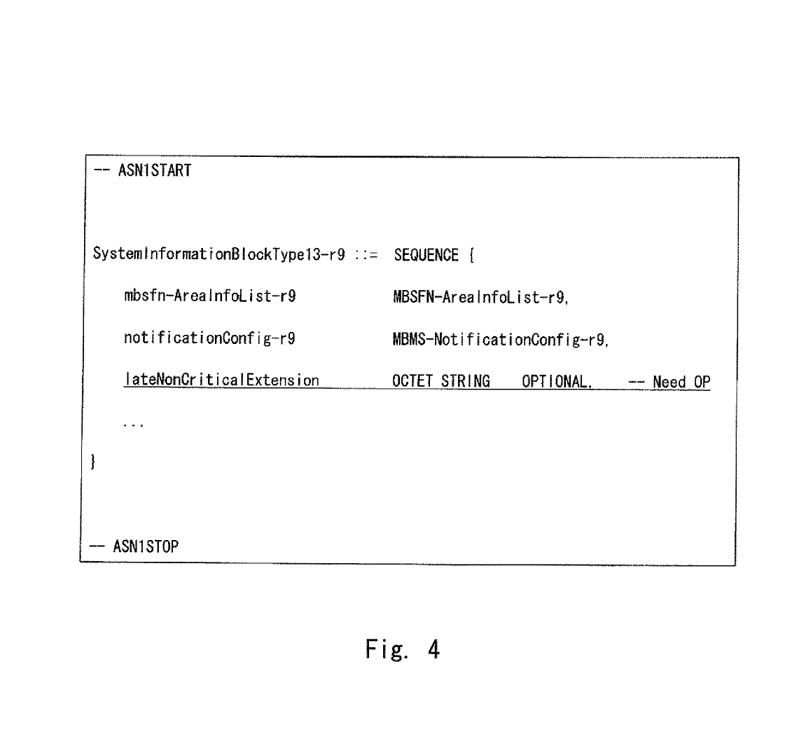

The report information generation unit 12 adds an 1-bit information element indicating whether to assign the unicast information to the MBSFN subframe to report information that the plurality of mobile stations (the mobile stations 20, 30, and 40) in the cell 50 are notified of. When, for example, TRUE is set as the 1-bit information element, it indicates that the unicast information is assigned to the MBSFN subframe. Furthermore, when FALSE is set, it indicates that the unicast information is not assigned to the MBSFN subframe. For example, in FIG. 4, an example of a case of adding to an SIB-13 (SystemINformationBlockType 13) of LTE Advanced the 1-bit information element indicating whether to assign the unicast information to the MBSFN subframe is shown. As shown in FIG. 4, the 1-bit information element may be added to a lateNonCriticalExtension.

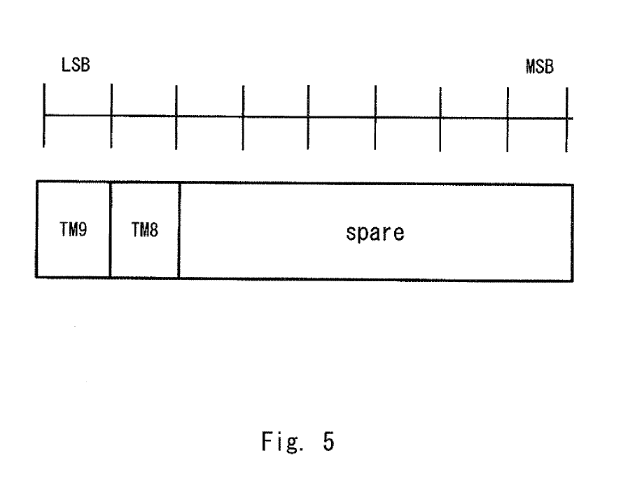

In addition, referring to FIG. 5, an example of a bit map of report information used when an information element is set for each transmission mode will be shown. A bit map in FIG. 5 shows a bit string having an 8-bit length. A length of the bit string is not limited to 8 bits, and may be, for example, a length of an integral multiple of 8 bits. An MSB of the bit string indicates a most significant bit, and an LSB indicates a least significant bit. In FIG. 5, an example where the LSB corresponds to the TM 9 (transmission mode 9) is shown. Therefore, the 1-bit information element indicating whether to assign the unicast information to the MBSFN subframe is set as the LSB.

Returning to FIG. 2, the data transmission unit 13 wirelessly transmits the report information generated in the report information generation unit 12 to the mobile stations 20, 30, and 40 in the cell. When the report information is transmitted to the mobile stations 20, 30, and 40, or when it is decided whether to assign the unicast information to the MBSFN subframe, the scheduling unit 14 performs scheduling of the radio resources in order to transmit data to the respective mobile stations. For example, the scheduling unit 14 decides the radio resources assigned to the mobile stations 20, 30, and 40 in a resource block unit.

In addition, when it is decided by the unicast assignment control unit 11 to assign the unicast information to the MBSFN subframe, the scheduling unit 14 assigns the plurality of resource blocks included in the MBSFN subframe to at least one of the mobile stations 20, 30, and 40, and transmits the unicast information. When it is decided by the unicast assignment control unit 11 not to assign the unicast information to the MBSFN subframe, the scheduling unit 14 performs assignment of the MBSFN subframe to at least one of the mobile stations 30 and 40 in order to transmit multicast information.

The data transmission unit 13 wirelessly transmits to the mobile stations 20, 30, and 40 radio resource assignment information decided on by the scheduling unit 14 and transmission data (the multicast information or the unicast information is included).

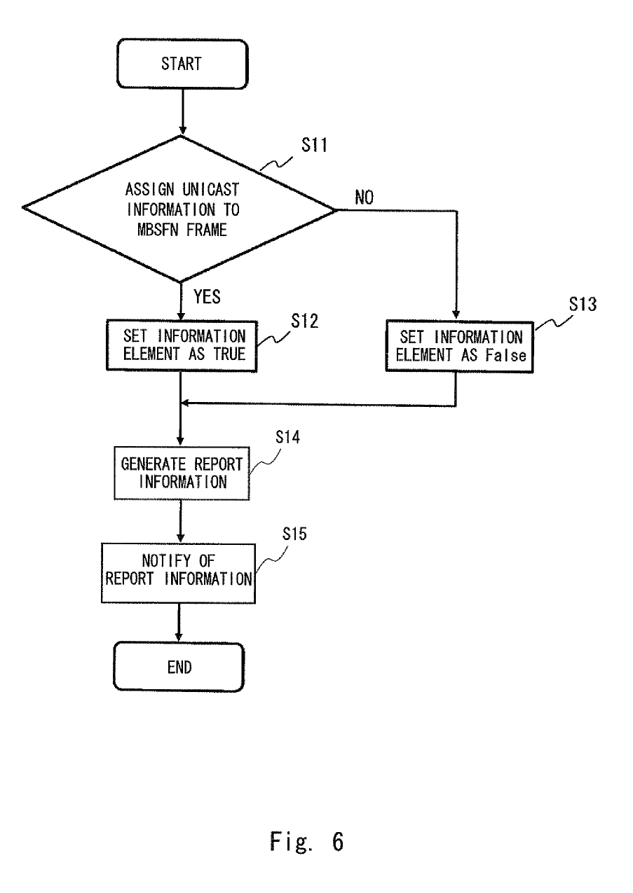

Subsequently, referring to FIG. 6, a flow of report information notification processing of the base station 10 pertaining to the embodiment 1 of the present invention will be explained. Firstly, the unicast assignment control unit 11 decides whether to assign unicast information to the MBSFN subframe (S11). If it is decided by the unicast assignment control unit 11 to assign the unicast information to the MBSFN subframe in step S11, the report information generation unit 12 sets TRUE as an information element of the TM 9 (S12), and generates report information (S 14).

If it is decided by the unicast assignment control unit 11 not to assign the unicast information to the MBSFN subframe in step S11, the report information generation unit 12 sets FALSE as the information element of the TM 9 (S12), and generates report information (S14).

Next, the data transmission unit 13 transmits the report information generated in the report information generation unit 12 to the mobile stations 20, 30, and 40 in the service area of the cell.

Here, although in regard to the explanations of FIGS. 2 and 6 it has been explained that the unicast assignment control unit 11 which the base station has been provided with decides whether to assign the unicast information to the MBSFN subframe, an apparatus other than the base station 10 may be provided with the unicast assignment control unit 11. That is, when it is decided by the apparatus other than the base station 10 whether to assign the unicast information to the MBSFN subframe, the base station 10 may generate report information using information decided upon by the apparatus other than the base station 10.

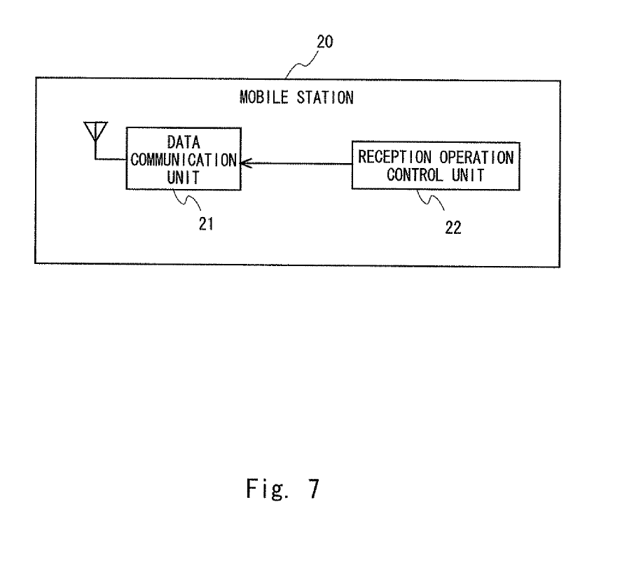

Subsequently, referring to FIG. 7, a configuration example of the mobile station 20 pertaining to the embodiment 1 of the present invention will be explained. Since the mobile stations 30 and 40 have configurations similar to that of the mobile station 20, explanations of configuration examples of the mobile stations 30 and 40 will be omitted.

The mobile station 20 is provided with a data communication unit 21 and a reception operation control unit 22. The data communication unit 21 wirelessly communicates with the base station 10. For example, the data communication unit 21 receives report information, radio resource assignment information, etc. from the base station 10. The data communication unit 21 outputs the received information to the reception operation control unit 22.

When the reception operation control unit 22 receives the report information transmitted from the base station 10, it identifies whether TRUE or FALSE is set as setting information of the TM 9. When the reception operation control unit 22 confirms that TRUE is set, it estimates that unicast information addressed to the mobile station 20 itself may be transmitted to an MBSFN subframe transmitted from the base station 10. Therefore, the reception operation control unit 22 performs a reception operation for receiving the unicast information relating to the MBSFN subframe transmitted from the base station 10.

When the reception operation control unit 22 confirms that FALSE is set, the reception operation control unit 22 estimates that the unicast information addressed to the mobile station 20 itself is not transmitted to the MBSFN subframe transmitted from the base station 10. Therefore, the reception operation control unit 22 does not perform a reception operation for receiving the unicast information in the MBSFN subframe transmitted from the base station 10.

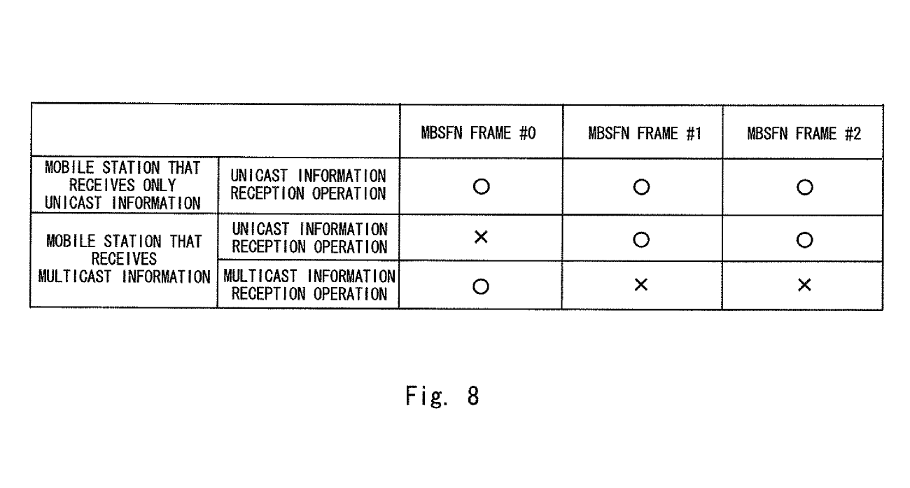

Next, referring to FIG. 8, a reception operation for MBSFN subframes in the mobile station 20 that receives only unicast information, and in the mobile stations 30 and 40 that receive unicast information and multicast information, the reception operation pertaining to the embodiment 1 of the present invention will be explained.

FIG. 8 shows the reception operation of MBSFN subframes in a case where TRUE is set as setting information of the TM 9 of report information. The mobile station 20 that does not receive multicast information but instead receives only unicast information performs the reception operation for the unicast information in MBSFN subframes #0 to #2. This is because TRUE is set as the setting information of the TM 9 of the report information, and because unicast information addressed to the mobile station 20 itself may be set for the MBSFN subframes.

The mobile stations 30 and 40 that receive both unicast information and multicast information are notified of an MBSFN subframe in which multicast information is transmitted among the MBSFN subframes #0 to #2 from the base station 10 in order to receive the multicast information. For example, assume that the multicast information is transmitted using the MBSFN subframe #0 in FIG. 8. In this case, the mobile stations 30 and 40 that receive unicast information and multicast information do not perform a reception operation for the unicast information in the MBSFN subframe #0; instead they perform a reception operation for the unicast information in the MBSFN subframes #1 and #2. In addition, the mobile stations 30 and 40 that receive unicast information and multicast information perform a reception operation for the multicast information in the MBSFN subframe #0, while they do not perform a reception operation for the multicast information in the MBSFN subframes #1 and #2.

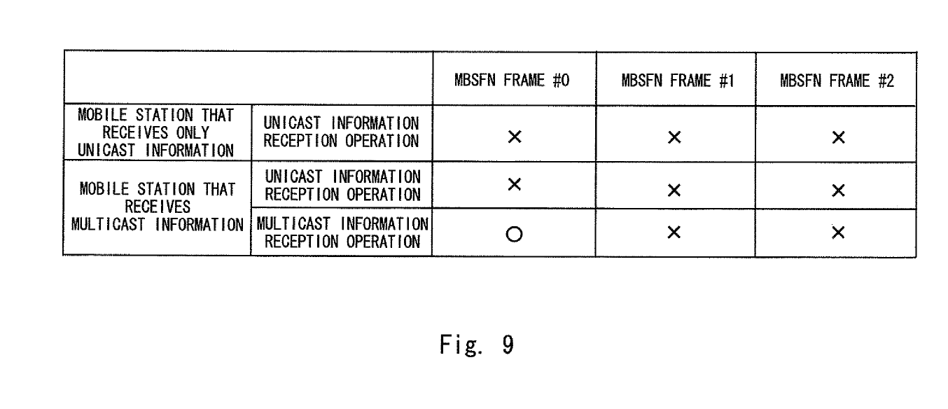

Next, referring to FIG. 9, a reception operation for MBSFN subframes in a case where FALSE is set as the setting information of the TM 9 of the report information will be explained. Assume that multicast information is transmitted using the MBSFN subframe #0 that, similarly to FIG. 8, is also shown in FIG. 9. In this case, the mobile station 20 that receives only unicast information and the mobile stations 30 and 40 that receive both the unicast information and multicast information do not perform a reception operation for the unicast information in the MBSFN subframes #0 to #2. In addition, the mobile stations 30 and 40 that receive unicast information and multicast information performs a reception operation for the multicast information in the MBSFN subframe #0.

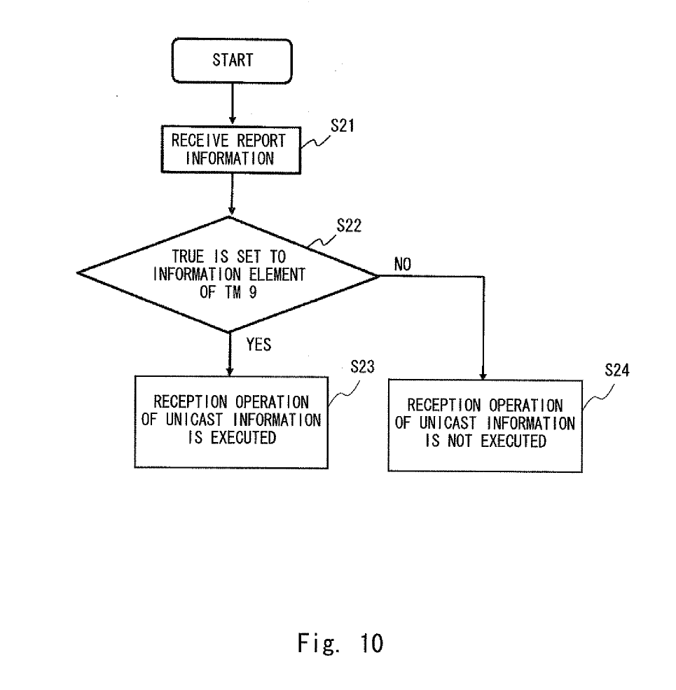

Next, referring to FIG. 10, a flow of processing of a reception operation for MBSFN subframes in the mobile station pertaining to the embodiment 1 of the present invention will be explained. In addition, FIG. 10 illustrates a reception operation for the mobile station that receives only unicast information.

Firstly, the data communication unit 21 receives report information from the base station 10 (S21). Next, the reception operation control unit 22 determines whether or not TRUE is set as the setting information of the TM 9 of the report information (S22). If the reception operation control unit determines that TRUE is set, it executes a reception operation for unicast information in the MBSFN subframe (S23). If the reception operation control unit 22 determines that TRUE is not set, i.e., FALSE is set, it does not execute the reception operation for the unicast information in the MBSFN subframe (S24).

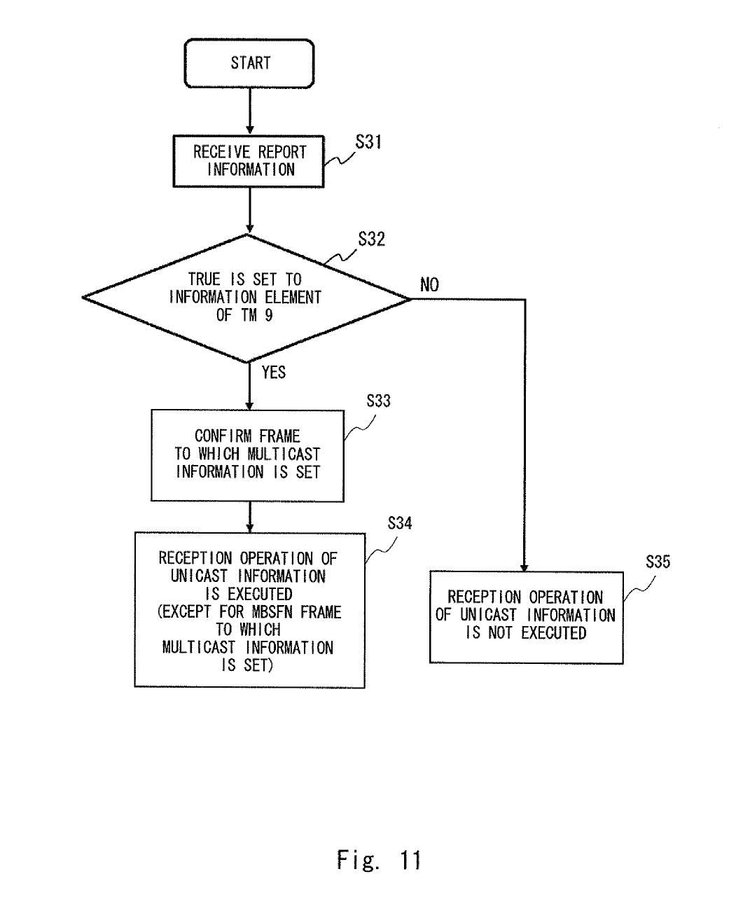

Next, referring to FIG. 11, a flow of processing of a reception operation of MBSFN subframes in the mobile station that receives unicast information and multicast information pertaining to the embodiment 1 of the present invention will be explained.

Firstly, the data communication unit 21 receives report information from the base station 10 (S31). Next, the reception operation control unit 22 determines whether or not TRUE is set as the setting information of the TM 9 of the report information (S32). If the reception operation control unit 22 determines that TRUE is set, it confirms an MBSFN subframe for which multicast information is set (S33). For example, as is similarly shown in FIGS. 8 and 9, in FIG. 11 it is shown that the reception operation control unit 22 confirms that the multicast information is transmitted using the MBSFN subframe #0.

Next, the reception operation control unit 22 performs a reception operation for unicast information in MBSFN subframes other than the MBSFN subframe in which the multicast information is transmitted (S34). Specifically, as shown in examples of FIGS. 8 and 9, the reception operation control unit 22 performs the reception operation for the unicast information in the MBSFN subframes #1 and #2. If the reception operation control unit 22 determines in step S32 that TRUE is not set, i.e., FALSE is set, it does not execute the reception operation of the unicast information in the MBSFN subframes #0 to #2.

As explained above, by using the mobile communication system in the embodiment 1 of the present invention, the base station 10 can notify the plurality of mobile stations in the service area of the managing cell of information on whether to set the unicast information to the MBSFN subframes using the report information. As a result of this, when the plurality of mobile stations are notified of information that the unicast information is not set to the MBSFN subframes, it becomes unnecessary for the plurality of mobile stations in the service area of the cell that the base station 10 manages to perform the reception operation for the unicast information in the MBSFN subframes. As a result of this, power consumption by the mobile stations can be decreased.

### Embodiment 2

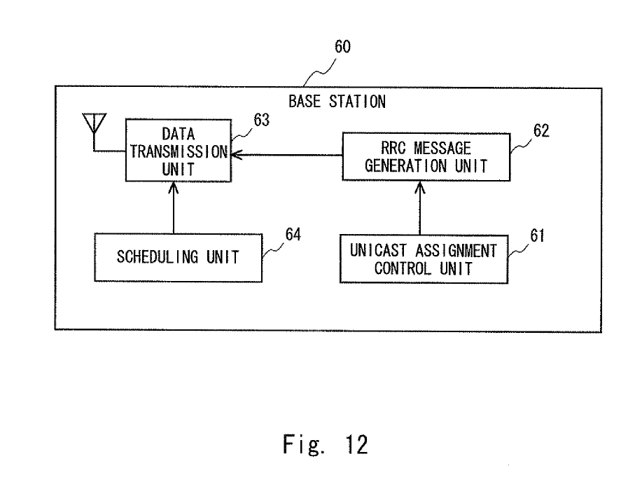

Next, referring to FIG. 12, a configuration example of a base station 60 pertaining to an embodiment 2 of the present invention will be explained. The base station 60 is provided with: a unicast assignment control unit 61; an RRC message generation unit 62; a data transmission unit 63; and a scheduling unit 64. Since the unicast assignment control unit 61, the data transmission unit 63, and the scheduling unit 64 have the same respective configurations as those of the unicast assignment control unit 11, the data transmission unit 13, and the scheduling unit 14 in the base station 10 of FIG. 2, detailed explanations thereof will be omitted.

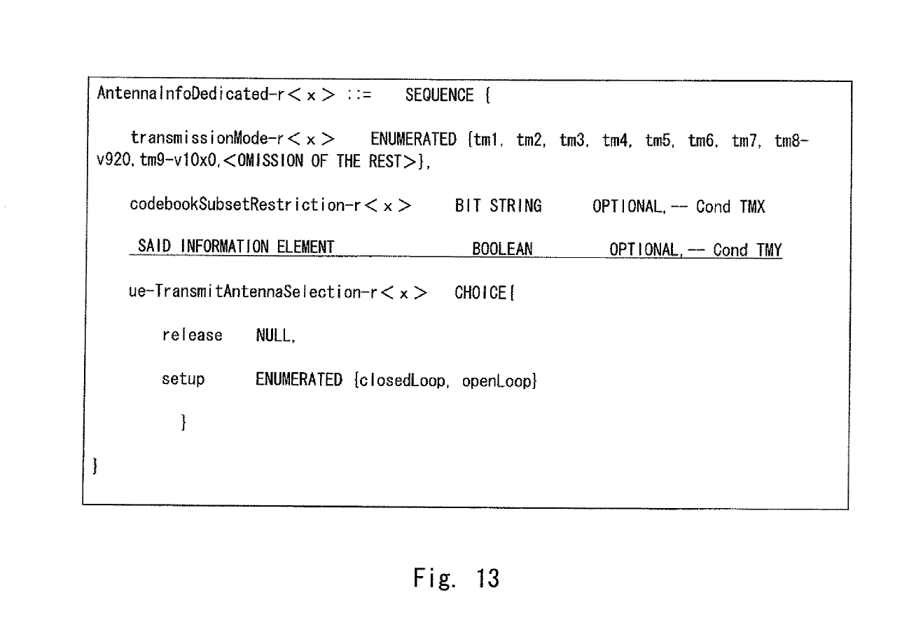

The RRC message generation unit 62 generates with respect to a mobile station a message with which setting of a transmission mode is performed. The message with which setting of the transmission mode is performed is, for example, an RRCConnectionSetup message in 3GPP. The RRCConnectionSetup message is used when the transmission mode of the mobile station is changed, etc. A plurality of mobile stations in a service area of a cell that the base station 60 manages are individually notified of the RRCConnectionSetup message. The RRC message generation unit 62 adds an information element of TRUE or FALSE to the RRCConnectionSetup message as setting information of the TM 9. Specifically, the RRC message generation unit 62 adds the information element as shown by an underline in FIG. 13. FIG. 13 shows an example where the information element is added to an RRCConnectionSetup message of LTE Release-<x>. A value not less than ten is set to <x>. Here, Cond TMY indicates that the information element exists when the TM 9 (transmission mode 9), or a transmission mode in which transmission of unicast information is supported by a subframe for multicast established after the TM 9, is set.

The base station 60 makes information generated in step 14 of FIG. 6 into an RRCConnectionSetup message, and executes processing that makes information for which notification is performed in S15 into an RRCConnectionSetup message. Steps S11 to S13 are executed similarly by the base station 60.

In addition, the mobile stations execute processing that makes information to be received into an RRCConnectionSetup message in step S21 of FIG. 10 and step S31 of FIG. 11. Steps S22 to S24 and steps S32 to S35 are executed similarly by the mobile stations in the embodiment 2 of the present invention.

As explained above, by using the mobile communication system pertaining to the embodiment 2 of the present invention, the base station 60 can notify the plurality of mobile stations in the service area of the managing cell of information on whether to set unicast information asMBSFN subframes individually using the RRCConnectionSetup message. As a result of this, when the mobile stations are notified of information that the unicast information is not set for the MBSFN subframes, it becomes unnecessary for the mobile stations which have received the notification to perform a reception operation for the unicast information in the MBSFN subframes. As a result of this, power consumption by the mobile stations can be decreased.

In addition, notification of the RRCConnectionSetup message is individually performed for each mobile station in the service area of the cell. Therefore, since the plurality of mobile stations can be individually controlled as compared with a case where notification of the information on whether to set the unicast information for the MBSFN subframes is performed using report information, effective use of radio resources can be achieved.

### Embodiment 3

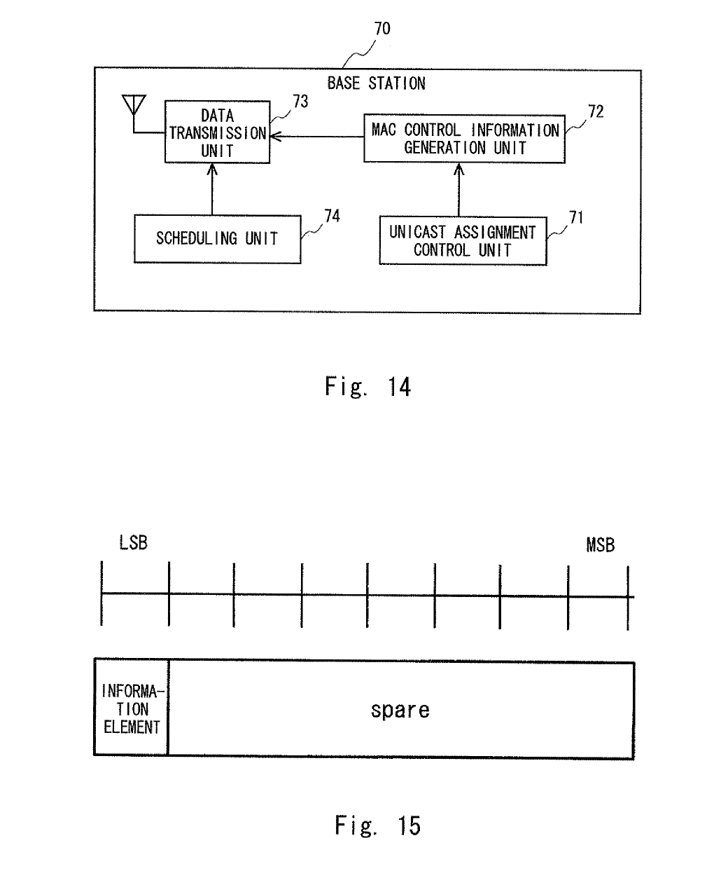

Next, referring to FIG. 14, a configuration example of a base station 70 pertaining to an embodiment 3 of the present invention will be explained. The base station 70 is provided with: a unicast assignment control unit 71; a MAC control information generation unit 72; a data transmission unit 73; and a scheduling unit 74. Since the unicast assignment control unit 71, the data transmission unit 73, and the scheduling unit 74 have the same respective configurations as those of the unicast assignment control unit 11, the data transmission unit 13, and the scheduling unit 14 in the base station 10 of FIG. 2, detailed explanations thereof will be omitted.

The MAC control information generation unit 72 generates with respect to mobile station MAC control information (MAC control element) that is made to communicate using a MAC (Media Access Control) layer. The MAC control information is multiplexed into transmission data which is then transmitted to the mobile station.

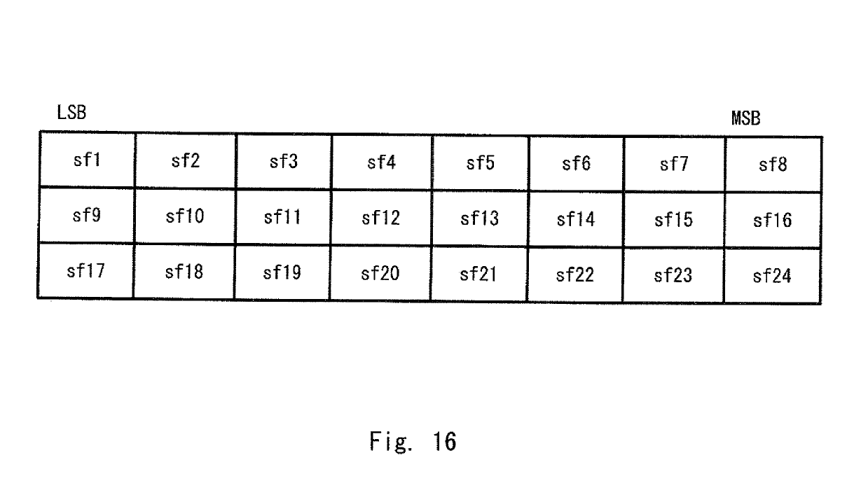

The MAC control information generation unit 72 sets information on whether to transmit unicast information in MBSFN subframes, for example, using an Index value 11010 (binary number) of an LCID (Logical Cnannel ID) of a DL SCH in 3GPP LTE. Specifically, the information element of TRUE or FALSE may be added to an LSB of a payload as setting information of the TM 9 as shown in FIG. 15. Alternatively, the information element of TRUE or FALSE may be added to a bit other than the LSB as the setting information of the TM 9.

The base station 70 makes information generated in step S14 of FIG. 6 into MAC control information, and executes processing that makes into MAC control information, notification which is performed in step S15. Steps S11 to S13 are executed in the base station 70 in a manner similar to that in which said steps are executed in the base station 60 in Embodiment 2.

In addition, the mobile station executes processing that makes information to be received into MAC control information in step S21 of FIG. 10 and step S31 of FIG. 11. Steps S22 to S24 and steps S32 to S35 are executed in the mobile station in the embodiment 3 of the present invention in a manner similar to that in which said steps are executed in the mobile station of Embodiment 1.

As shown in FIG. 15, when the base station 70 adds an information element to a payload of MAC control information, and transmits the MAC control information to the mobile station, dynamic control of the mobile station cgreater (OK?) than that in the embodiments 1 and 2 can be achieved. Specifically, when it is determined by the base station 70 that unicast information is assigned to MBSFN subframes with respect to the mobile station, the base station 70 sets TRUE as an information element, and transmits the MAC control information to the mobile station. After that, the base station 70 starts assignment of the unicast information to the MBSFN subframes. Furthermore, when the base station 70 cancels the assigning of the unicast information to the MBSFN subframes, it sets FALSE as the information element, and transmits the MAC control information to the mobile station. In the manner described above, when the MAC control information is used, a set value of the information element can be changed with respect to the mobile station according to whether the unicast information transmitted using the MBSFN subframe exists or does not exist. Therefore, dynamic control of the mobile station can be achieved.

In addition, the MAC control information generation unit 72 may conduct automatical control using a timer change of the set value of the information element from TRUE to FALSE or from FALSE to TRUE.

In addition, the MAC control information is multiplexed by the data transmission of the unicast information, and notification thereof is transmitted from the base station 70 to the mobile station. Therefore, when the base station 70 notifies the mobile station of changing the information element from FALSE to TRUE, the base station 70 needs to multiplex the MAC control information into data transmitted as a normal frame.

Furthermore, operation of the mobile station when notification of changing the information element is not performed can be previously decided by previously specifying TRUE or FALSE as to the information element as a default value.

Here, although the case has been explained in the embodiment 3 where the information element is added to the payload of the MAC control information, the information element may be added to a resource assignment message of the transmission data in the normal frame, and notification thereof may be transmitted (OK?) to the mobile station. A DCI format, for example, (OK?) is used for the resource assignment message in LTE of 3GPP. Although a message corresponding to the TM 9 (transmission mode 9) is set as DCIformat2C in the DCI format, one bit of the information element, for example, (OK?) may be added thereto. The information element is added to the resource assignment message of the transmission data, and thereby greater dynamic control of the mobile station can be performed as compared with the case where the information element is added to the MAC control information. This is because a frequency where the resource assignment message of the transmission data is transmitted to the mobile station is higher than a frequency where the MAC control information is multiplexed into the transmission data to be transmitted to the mobile station.

### Embodiment 4

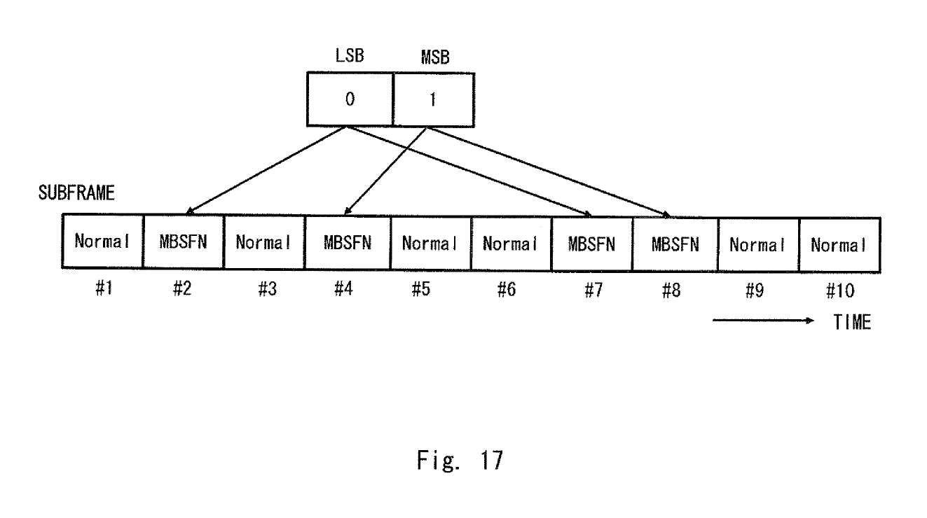

Subsequently, using a bit map, an example where notification of an MBSFN subframe to which unicast information is assigned is explicitly transmitted (OK?) from a base station to a mobile station. Each bit of a payload shown in FIG. 16 corresponds to the MBSFN subframes. In FIG. 16, information elements for twenty-four subframes are assigned to the 24-bit payload, and notification thereof is transmitted to the mobile station. Here, a bit map shown in FIG. 16 may be added to report information, a setting message of a transmission mode, MAC control information, etc., and notification thereof may be transmitted to the mobile station.

Similar to the embodiments 1 to 3, the base station sets TRUE or FALSE for each bit. MBSFN subframes corresponding to bits for which TRUE has been set are used for assignment of transmission of unicast information. Alternatively, the MBSFN subframes corresponding to the bits for which TRUE has been set may perhaps be used for assignment of transmission of the unicast information.

Transmission of the unicast information is not performed in MBSFN subframes corresponding to bits for which FALSE has been set. The mobile station can suppress wasteful power consumption by not performing a reception operation for the unicast information in the MBSFN subframes set as FALSE. The bit map may be periodically applied to the mobile station. The period may be set to be the same as a period of the MBSFN subframe, a multiple, or an aliquot thereof.

Subsequently, referring to FIG. 17, an example of mapping of a period of MBSFN subframes and a bit map pertaining to an embodiment 4 of the present invention will be explained. In FIG. 17, the MBSFN subframe is assigned to four subframes (subframes #2, #4, #7, and #8) in a ten-subframe period. The bit map includes two bits, and indicates an example where the bit map is applied twice per one bit during the 10-subframe period. Subframes #2 and #7 correspond to an LSB of the bit map. Since the LSB of the bit map is 0 (FALSE), unicast information is not assigned to the MBSFN subframes #2 and #7. Subframes #4 and #8 correspond to an MSB of the bit map. Since the MSB of the bit map is 1 (TRUE), unicast information is assigned to the subframes #4 and #8, which are the MBSFN subframes, or may be assigned thereto.

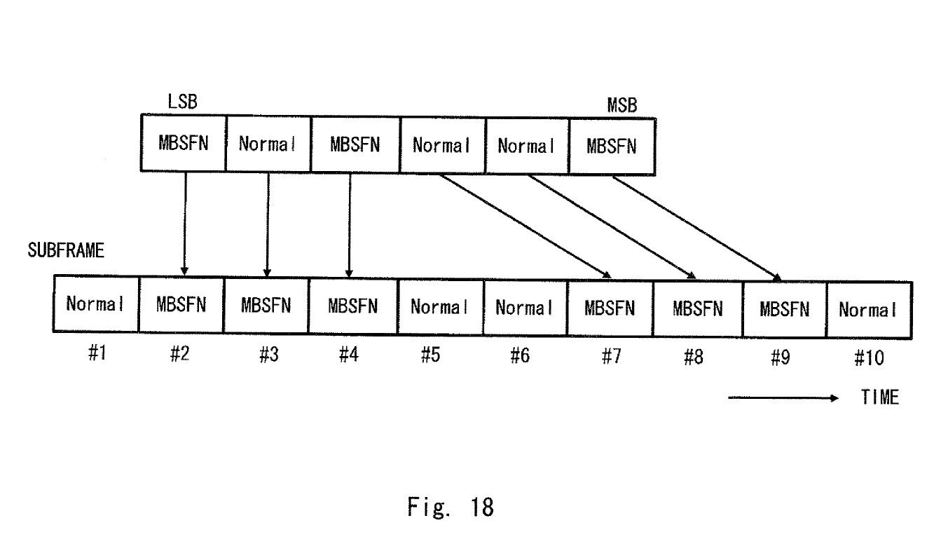

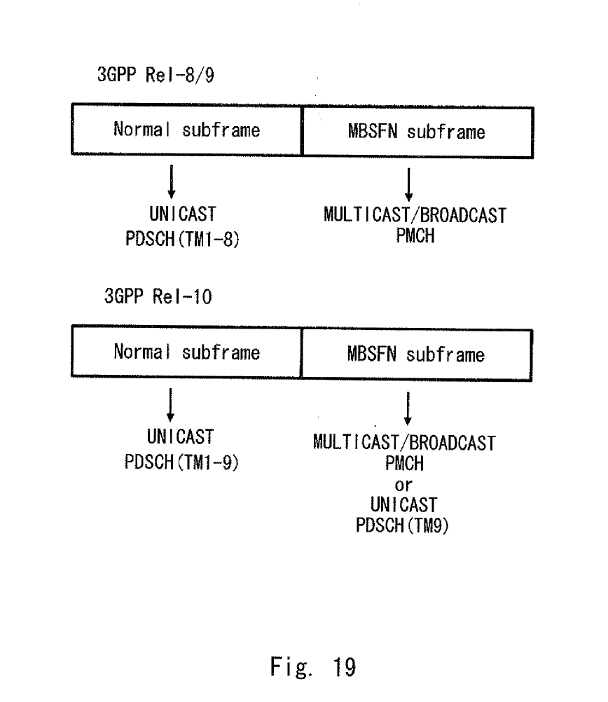

Subsequently, referring to FIG. 18, another example of mapping of the period of the MBSFN subframes and that of the bit map pertaining to the embodiment 4 of the present invention will be explained. In FIG. 18, subframes used as the MBSFN subframes are set as the subframes #2, #3, #4, #7, #8, and #9 among the ten subframes. Along with this, a size of the bit map is set as six bits. In a manner described above, a payload size of the bit map may be decided according to the number of MBSFN subframes. That is, respective values of the bit map and the MBSFN subframe may be made to have a one-to-one correspondence.

In addition, when notification can be performed more dynamically, such as a case where notification of the bit map is performed by means of the MAC control information, the bit map notification of which has been performed is not periodically applied, but instead may be applied only once. After application of the bit map once is finished, the base station again notifies the mobile station of the bit map, or a default value may be applied, etc.

In addition, it is also possible to combine control by the bit map explained in the embodiment 4 with any of the embodiments 1 to 3. For example, the present invention may be configured such that the bit map becomes effective when a 1-bit information element notification of which is transmitted from the base station to the mobile station is set as TRUE, and that in all the MBSFN subframes, unicast information is not transmitted to the mobile station to which notification of the 1-bit information element has been transmitted regardless of the bit map when the 1-bit information element is set as FALSE. Alternatively, the 1-bit information element may be set as the default value.

Although the present invention has been described as a configuration of a hardware in the above-mentioned embodiments, the present invention is not limited to this. In the present invention, it is also possible to achieve the processing described in step S14 of FIG. 6 by the base stations 10, 60, and 70 by making a CPU (Central Processing Unit) execute a computer program.

In the above-mentioned examples, a program is stored using various types of non-transitory computer readable media, and can be supplied to a computer. The non-transitory computer readable medium includes various types of tangible storage media. Examples of the non-transitory computer readable medium include: a magnetic recording medium (for example, a flexible disk, a magnetic tape, or a hard disk drive); a magneto-optical recording medium (for example, a magneto-optical disk); a CD-ROM (Read Only Memory); a CD-R; a CD-R/W; a semiconductor memory (for example, a mask ROM or a PROM (Programmable ROM); an EPROM (Erasable PROM); a flash ROM; and a RAM (Random Access Memory). In addition, the program may be supplied to the computer by various types of transitory computer readable media. Examples of the transitory computer readable medium include an electrical signal, an optical signal, and an electromagnetic wave. The transitory computer readable medium can supply the program to the computer through a wired communication channel, such as an electric wire and an optical fiber, or a radio communication channel.

It is to be noted that the present invention is not limited to the above-described embodiments, and that it can be appropriately changed without departing from the subject matter. For example, in the above-mentioned embodiments, examples have been explained of deciding whether multicast information is transmitted to a subframe unit or unicast information is transmitted thereto. In contrast with this, it may be decided by a subcarrier unit having a same time slot whether the multicast information is transmitted or the unicast information is transmitted. Furthermore, although the examples using the TM 9 have been explained in the above-mentioned embodiments, the present invention can be also applied to a TM 8 and a TM newly added in the future.

Hereinbefore, although the invention in the present application has been explained with reference to the embodiments, the invention in the present application is not limited by the above. Various changes that those skilled in the art can understand within the scope of the invention can be made to the configuration and details of the invention in the present application.

This application claims priority based on Japanese Patent Application No. 2011-162332 filed on Jul. 25, 2011, and the entire disclosure thereof is incorporated herein.

### REFERENCE SIGNS LIST

10 Base station
11 Unicast assignment control unit
12 Report information generation unit
13 Data transmission unit
14 Scheduling unit
20 Mobile station
21 Data communication unit
22 Reception operation control unit
30 Mobile station
40 Mobile station
50 Cell
60 Base station
61 Unicast assignment control unit
62 RRC message generation unit
63 Data transmission unit
64 Scheduling unit
70 Base station
71 Unicast assignment control unit
72 MAC control information generation unit
73 Data transmission unit
74 Scheduling unit

1. A mobile communication system comprising:
a radio base station configured so as to notify a mobile station of first information on whether to transmit unicast information using a first radio resource group, when it is specified that the first radio resource group can be utilized for transmission of multicast information and the unicast information and includes a plurality of radio resources, and that a second radio resource group is different from the first radio resource group; and
the mobile station configured so as to control reception operation of the first radio resource group based on the first information received from the radio base station.

2. The mobile communication system according to claim 1, wherein the radio base station is configured so as to assign radio resources included in the first radio resource group and the second radio resource group to a plurality of mobile stations, after it is decided whether to transmit the unicast information using the first radio resource group.

3. The mobile communication system according to claim 1, wherein the radio base station is configured so as to set the first information as a message notification of which is transmitted simultaneously to a plurality of mobile devices in a service area of a cell.

4. The mobile communication system according to claim 3, wherein the message notification of which is transmitted simultaneously to the plurality of mobile devices in the service area of the cell comprises a System Information Block.

5. The mobile communication system according to claim 1, wherein the radio base station is configured so as to set the first information as a message notification of which is individually transmitted to each of the plurality of mobile devices in the service area of the cell.

6. The mobile communication system according to claim 5, wherein the message notification of which is individually transmitted to each of the plurality of mobile devices in the service area of the cell comprises an RRCConectionSetup message, a MAC control element, or a DCI format.

7. The mobile communication system according to claim 1, wherein the second radio resource group is not utilized for transmission of the multicast information.

8. The mobile communication system according to claim 1, wherein the first and second radio resource groups comprise frames including a plurality of time slots.

9. The mobile communication system according to claim 8, wherein the first radio resource group comprises an MBSFN subframe that can be utilized for transmission of both multicast information and unicast information, and the second radio resource comprises a normal subframe that can be utilized for transmission of only the unicast information.

10. The mobile communication system according to claim 1, wherein
when the first information indicates that the unicast information is transmitted using the first radio resource group, the mobile station is configured so as to perform reception operation for the unicast information that can be set to the first radio resource group, and
when the first information indicates that the unicast information is not transmitted using the first radio resource group, the mobile station is configured so as not to perform reception operation of the unicast information that can be set to the first radio resource group.

11. The mobile communication system according to claim 10, wherein when the mobile station comprises a first mobile station that receives only the unicast information from the radio base station or a second mobile station that receives both the multicast information and the unicast information, and the first information indicates that the unicast information is not transmitted using the first radio resource group, the first and second mobile stations are configured so as not to perform reception operation of the unicast information that can be set to the first radio resource group.

12. The mobile communication system according to claim 10, wherein when the mobile station comprises the second mobile station, and the first information indicates that the unicast information is transmitted using the first radio resource group, the second mobile station is configured so as not to perform reception operation of the unicast information in a first radio resource in which the multicast information is transmitted among a plurality of the first radio resource groups.

13. A radio base station comprising a data transmission unit that transmits first information on whether to transmit unicast information using a first radio resource group when it is specified that the first radio resource group can be utilized for transmission of multicast information and the unicast information and includes a plurality of radio resources, and that a second radio resource group is different from the first radio resource group.

14. The radio base station according to claim 13, further comprising for a scheduling unit that assigns radio resources included in the first radio resource group and the second radio resource group to a plurality of mobile stations, after it is decided whether to transmit the unicast information using the first radio resource group.

15. The radio base station according to claim 13, wherein the data transmission unit is set the first information as a message notification of which is transmitted simultaneously to a plurality of mobile devices in a service area of a cell, and notifies the mobile stations of the message.

16. The radio base station according to claim 15, wherein the message notification of which is transmitted simultaneously to the plurality of mobile devices in the service area of the cell comprises a System Information Block.

17. The radio base station according to claim 13, wherein the data transmission unit is set the first information as a message notification of which is individually transmitted to each of the plurality of mobile devices in the service area of the cell, and notifies the mobile stations of the message.

18. The radio base station according to claim 17, wherein the message notification of which is individually transmitted to each of the plurality of mobile devices in the service area of the cell comprises an RRCConectionSetup message, a MAC control element, or a DCI format.

19. The radio base station according to claim 13, wherein the second radio resource group is not utilized for transmission of the multicast information.

20. The radio base station according to claim 13, wherein the first and second radio resource groups comprise frames including a plurality of time slots.

21. The radio base station according to claim 20, wherein the first radio resource group comprises an MBSFN subframe that can be utilized for transmission of both multicast information and unicast information, and the second radio resource comprises a normal subframe that can be utilized for transmission of only the unicast information.

22. A mobile station comprising a reception operation control unit that controls reception operation of a first radio resource group based on first information on whether or not unicast information is transmitted from a radio base station using the first radio resource group, when it is specified that the first radio resource group can be utilized for transmission of multicast information and the unicast information and includes a plurality of radio resources, and that a second radio resource group is different from the first radio resource group.

23. The mobile station according to claim 22, wherein
when the first information indicates that the unicast information is transmitted using the first radio resource group, the reception operation control unit performs reception operation of the unicast information that can be set as to the first radio resource group, and
when the first information indicates that the unicast information is not transmitted using the first radio resource group, the reception operation control unit does not perform a reception operation of the unicast information that can be set to the first radio resource group.

24. The mobile station according to claim 23, wherein when the first information indicates that the unicast information is not transmitted using the first radio resource group, and only the unicast information is received from the radio base station or both the multicast information and the unicast information are received, the reception operation control unit does not perform reception operation of the unicast information that can be set to the first radio resource group.

25. The mobile station according to claim 23, wherein when the first information indicates that the unicast information is transmitted using the first radio resource group, and the multicast information and the unicast information are received from the radio base station, the reception operation control means unit does not perform reception operation of the unicast information in a first radio resource group in which the multicast information is transmitted among a plurality of the first radio resource groups.

26. A mobile station that wirelessly communicates with the radio base station according to claim 13.

27. A data transmission method, wherein when it is specified that a first radio resource group can be utilized for transmission of multicast information and unicast information and includes a plurality of radio resources, and that a second radio resource group is different from the first radio resource group, first information on whether to transmit the unicast information is transmitted to a mobile station using the first radio resource group.

28. A data reception method, wherein when it is specified that a first radio resource group can be utilized for transmission of multicast information and unicast information and includes a plurality of radio resources, and that a second radio resource group is different from the first radio resource group, reception operation for the first radio resource group is controlled based on first information on whether or not the unicast information is transmitted from a radio base station using the first radio resource group.

29. A non-transitory computer readable medium, wherein a program is stored that makes a computer execute processing that transmits to a mobile station first information on whether to transmit unicast information using a first radio resource group, when it is specified that the first radio resource group can be utilized for transmission of multicast information and the unicast information and includes a plurality of radio resources, and that a second radio resource group is different from the first radio resource group.
